(19) United States
(12) Patent Application Publication
(10) Pub. No.: US 2025/0055144 A1
(43) Pub. Date: Feb. 13, 2025

(54) BUSBAR DESIGNS FOR JOINING BATTERY CELLS

(71) Applicant: FORD GLOBAL TECHNOLOGIES, LLC, Dearborn, MI (US)

(72) Inventors: Yongcai WANG, Ann Arbor, MI (US); Chi PAIK, Grosse Ile, MI (US)

(21) Appl. No.: 18/446,699

(22) Filed: Aug. 9, 2023

(51) Int. Cl. H01M 50/503; B60L 50/60; H01M 10/0525; H01M 50/211; H01M 50/507; H01M 50/516

(52) U.S. Cl. CPC H01M 50/503; B60L 50/60; H01M 10/0525; H01M 50/211; H01M 50/507; H01M 50/516; H01M 2220/20

(57) ABSTRACT

Busbars are provided for electrically connecting battery cells within a traction battery pack. An exemplary busbar may include features for locating and positioning tab terminals of neighboring battery cells. For example, the busbar may include openings and ribs that separate adjacent openings. A first tab terminal of a first battery cell may be positioned for connection at a first side of the rib, and a second tab terminal of a second battery cell may be positioned for connection at a second side of the rib. The first and second tab terminals may each be secured (e.g., welded) to the rib.

### TECHNICAL FIELD

This disclosure relates generally to electrified vehicle traction battery packs, and more particularly to busbars for electrically connecting battery cells of traction battery packs.

### BACKGROUND

A high voltage traction battery pack typically powers the electric machines and other electrical loads of an electrified vehicle. The traction battery pack includes a plurality of battery cells. The battery cells must be reliably connected to one another in order to provide the voltage and power levels necessary for achieving vehicle propulsion.

### SUMMARY

A traction battery pack according to an exemplary aspect of the present disclosure includes, among other things, a busbar including a rib, a first battery cell including a first tab terminal connected to a first side of the rib, and a second battery cell including a second tab terminal connected to a second side of the rib.

In a further non-limiting embodiment of the foregoing traction battery pack, the rib is configured as an L-bend that is established by a bent portion of the busbar.

In a further non-limiting embodiment of either of the foregoing traction battery packs, the bent portion is provided within a crossbeam of the busbar. The crossbeam connects between a first frame member and a second frame member of the busbar.

In a further non-limiting embodiment of any of the foregoing traction battery packs, the rib is configured as a T-rib.

In a further non-limiting embodiment of any of the foregoing traction battery packs, the rib extends in a direction away from the first battery cell and the second battery cell.

In a further non-limiting embodiment of any of the foregoing traction battery packs, a weld secures the first tab terminal to the first side of the rib and secures the second tab terminal to the second side of the rib.

In a further non-limiting embodiment of any of the foregoing traction battery packs, the rib is positioned between a first opening and a second opening formed through the busbar.

In a further non-limiting embodiment of any of the foregoing traction battery packs, a first end portion of the first tab terminal extends through the first opening, and a second end portion of the second tab terminal extends through the second opening.

In a further non-limiting embodiment of any of the foregoing traction battery packs, the first end portion and the second end portion are Z-shaped.

In a further non-limiting embodiment of any of the foregoing traction battery packs, the first end portion and the second end portion are unbent or substantially straight.

In a further non-limiting embodiment of any of the foregoing traction battery packs, the busbar is held within a busbar frame. The busbar frame and the busbar establish a bus bar module of the traction battery pack.

In a further non-limiting embodiment of any of the foregoing traction battery packs, the busbar module further includes a second busbar held within the busbar frame.

A traction battery pack according to another exemplary aspect of the present disclosure includes, among other things, a busbar including a first opening, a second opening, and a rib between the first opening and the second opening. A first battery cell includes a first housing and a first tab terminal extending from the first housing. A second battery cell includes a second housing and a second tab terminal extending from the second housing. The first tab terminal extends through the first opening and is connected to a first side of the rib, and the second tab terminal extends through the second opening and is connected to a second side of the rib. A weld secures the first tab terminal, the rib, and the second tab terminal together.

In a further non-limiting embodiment of the foregoing traction battery pack, the rib is configured as an L-bend that is established by a bent portion of the busbar.

In a further non-limiting embodiment of either of the foregoing traction battery packs, the rib is configured as a T-rib.

In a further non-limiting embodiment of any of the foregoing traction battery packs, the rib extends in a direction away from the first battery cell and the second battery cell.

In a further non-limiting embodiment of any of the foregoing traction battery packs, a first end portion of the first tab terminal extends through the first opening, and a second end portion of the second tab terminal extends through the second opening.

In a further non-limiting embodiment of any of the foregoing traction battery packs, the first end portion and the second end portion are Z-shaped.

In a further non-limiting embodiment of any of the foregoing traction battery packs, the first end portion and the second end portion are unbent or substantially straight.

In a further non-limiting embodiment of any of the foregoing traction battery packs, the first end portion and the second end portion are positioned on an opposite side of the busbar from the first housing and the second housing.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a perspective view of a traction battery pack for an electrified vehicle.

FIG. 3 is a highly schematic cross-sectional view of the traction battery pack of FIG. 2.

FIG. 4 illustrates a battery cell of a battery array of a traction battery pack.

FIG. 5 illustrates a busbar module that includes multiple busbars for joining tab terminals of a grouping of battery cells.

FIG. 6 is a cross-sectional view through section 6-6 of FIG. 5.

FIG. 7 is a cross-sectional view of another exemplary busbar module for joining tab terminals of a grouping of battery cells.

FIGS. 8A, 8B, and 8C illustrate an exemplary busbar.

FIGS. 9A, 9B, and 9C illustrate another exemplary busbar.

### DETAILED DESCRIPTION

This disclosure details busbars that are configured for electrically connecting battery cells within a traction battery pack. An exemplary busbar may include features for locating and positioning tab terminals of neighboring battery cells. For example, the busbar may include openings and ribs that are disposed between adjacent openings. A first tab terminal of a first battery cell may be positioned for connection at a first side of the rib, and a second tab terminal of a second battery cell may be positioned for connection at a second side of the rib. The first and second tab terminals may each be secured (e.g., welded) to the rib. These and other features are discussed in greater detail in the following paragraphs of this detailed description.

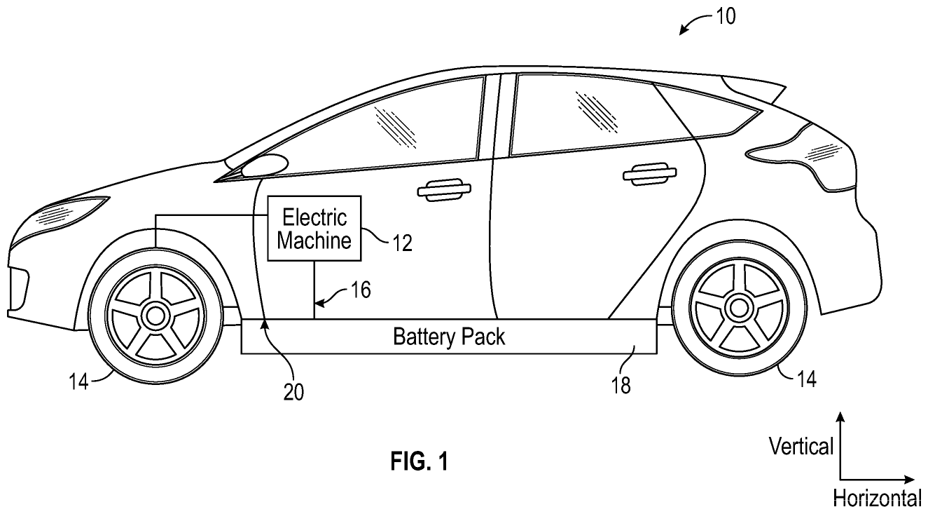

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

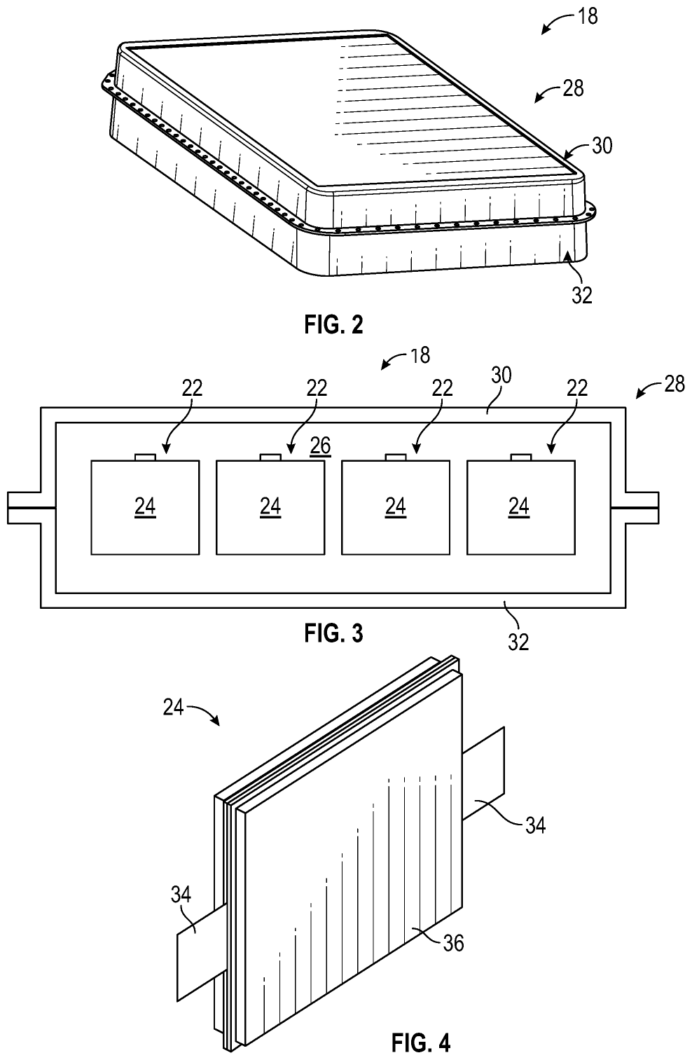

FIGS. 2 and 3 illustrate additional details associated with the traction battery pack 18 of the electrified vehicle 10. The traction battery pack 18 may include one or more battery arrays 22 (e.g., battery assemblies or groupings of rechargeable battery cells 24) capable of outputting electrical power to power the electric machine 12 and/or other electrical loads of the electrified vehicle 10. Other types of energy storage devices and/or output devices could alternatively or additionally be used to electrically power the electrified vehicle 10.

The battery cells 24 may be stacked side-by-side along a stack axis to construct a grouping of battery cells 24, sometimes referred to as a “cell stack.” In the highly schematic depiction of FIG. 3, the battery cells 24 are stacked in a direction into the page to construct each battery array 22, and thus the battery arrays 22 may extend in cross-car direction. However, other configurations may also be possible. The total number of battery arrays 22 and battery cells 24 provided within the traction battery pack 18 is not intended to limit this disclosure.

In an embodiment, the battery cells 24 of each battery array 22 are pouch style, lithium-ion cells. However, battery cells having other geometries (cylindrical, prismatic, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 (see FIG. 3) of an enclosure assembly 28. The enclosure assembly 28 may include an enclosure cover 30 and an enclosure tray 32. The enclosure cover 30 may be secured (e.g., bolted, welded, adhered, etc.) to the enclosure tray 32 to provide the interior area 26. The size, shape, and overall configuration of the enclosure assembly 28 is not intended to limit this disclosure.

FIG. 4 illustrates one of the battery cells 24 that can be provided within the traction battery pack 18. Each battery cell 24 may include a housing 36 and a pair of tab terminals 34 that project outwardly from the housing 36. In an embodiment, each battery cell 24 includes two tab terminals 34, with one tab terminal 34 protruding outwardly at each opposing side of the housing 36. In some implementations, an aluminum fin may provide each housing 36. In other implementations, the housing 36 is a multi-layered structure including an aluminum film layer and a polymer layer. However, other housing configurations are further contemplated within the scope of this disclosure.

The tab terminals 34 of the battery cells 24 of each battery array 22 must be reliably connected to one another in order to provide the voltage and power levels necessary for achieving vehicle propulsion. Busbars are sometimes used for making these connections, however, it can be difficult to properly position and align the tab terminals 34 relative to the busbar during assembly and welding processes. This disclosure is therefore specifically directed to busbar modules that includes busbars having features designed for facilitating proper positioning and alignment of the tab terminals 34 when joining the tab terminals 34 to a busbar.

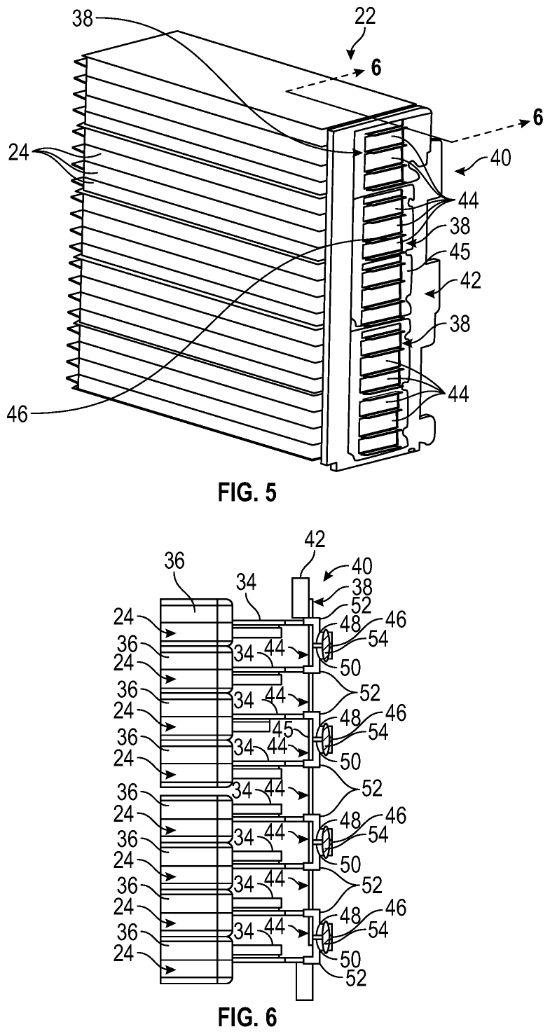

FIGS. 5 and 6 illustrate a busbar module 40 according to an exemplary embodiment of this disclosure. The busbar module 40 may include a plurality of busbars 38 and a busbar frame 42. Each of the busbars 38 may be held within the busbar frame 42 for establishing the busbar module 40.

Although three busbars 38 are shown in this embodiment, the busbar module 40 could include a greater or fewer number of busbars within the scope of this disclosure. Moreover, at least one of the busbars 38 could include a different size from the other busbars 38 of the busbar module 40. Therefore, other configurations are contemplated within the scope of this disclosure.

The busbars 38 of the busbar module 40 may be joined to tab terminals 34 (best seen in FIG. 6) of a grouping of battery cells 24 for electrically connecting the battery cells 24. The grouping of battery cells 24 may be part of one of the battery arrays 22 of the traction battery pack 18, for example. Once electrically coupled, the battery cells 24 may supply electrical power for powering various components of the electrified vehicle 10. In the illustrated embodiment, the busbar module 40 is configured to join the tab terminals 34 of twenty battery cells 24. However, the busbar module 40 could be configured to join a greater or fewer number of tab terminals 34/battery cells 24 within the scope of this disclosure.

The busbars 38 may be metallic components of the busbar module 40, and the busbar frame 42 may be a plastic component of the busbar module 40. In an embodiment, the busbars 38 are made of copper or aluminum, and the busbar frame 42 is made of polypropylene or polyethylene. However, other materials are contemplated within the scope of this disclosure.

Each busbar 38 may include a plurality of openings 44 (see also FIGS. 8A-8C). Each opening 44 may be formed through a body 45 of the busbar 38 and may be sized for receiving one of the cell tab terminals 34. The cell tab terminals 34 may extend through the openings 44 such that at least a portion of each cell tab terminal 34 is located on an opposite side of the busbar 38 from the housing 36 of its respective battery cell 24.

Each busbar 38 may additionally include a plurality of ribs 46. One rib 46 may be provided between each adjacent set of openings 44 of the busbar 38. The ribs 46 may therefore at least partially separate the openings 44 from one another. The ribs 46 may protrude from the body 45 of the busbar 38 in a direction that extends away from the battery cells 24.

As shown best in FIG. 6, each rib 46 may be arranged to interface with the tab terminals 34 of at least two neighboring battery cells 24. For example, the tab terminal 34 of one of the battery cells 24 may extend through one of the openings 44 in order to position an end portion 52 of the tab terminal 34 for connection relative to a first side 48 of the rib 46, and the tab terminal 34 of a neighboring battery cell 24 may extend through another one of the openings 44 in order to position an end portion 52 of the tab terminal 34 for connection relative to a second side 50 of the rib 46. The first side 48 and the second side 50 of the rib 46 may each provide a relatively flat surface for locating and/or supporting the end portions 52 of the tab terminals 34.

Once properly positioned, the end portions 52 of the tab terminals 34 may be joined to the ribs 46 by one or more welds 54. The welds 54 may be linear or non-linear welds and may be formed using any suitable welding process (e.g., spot welding, ultrasonic welding, laser welding, etc.).

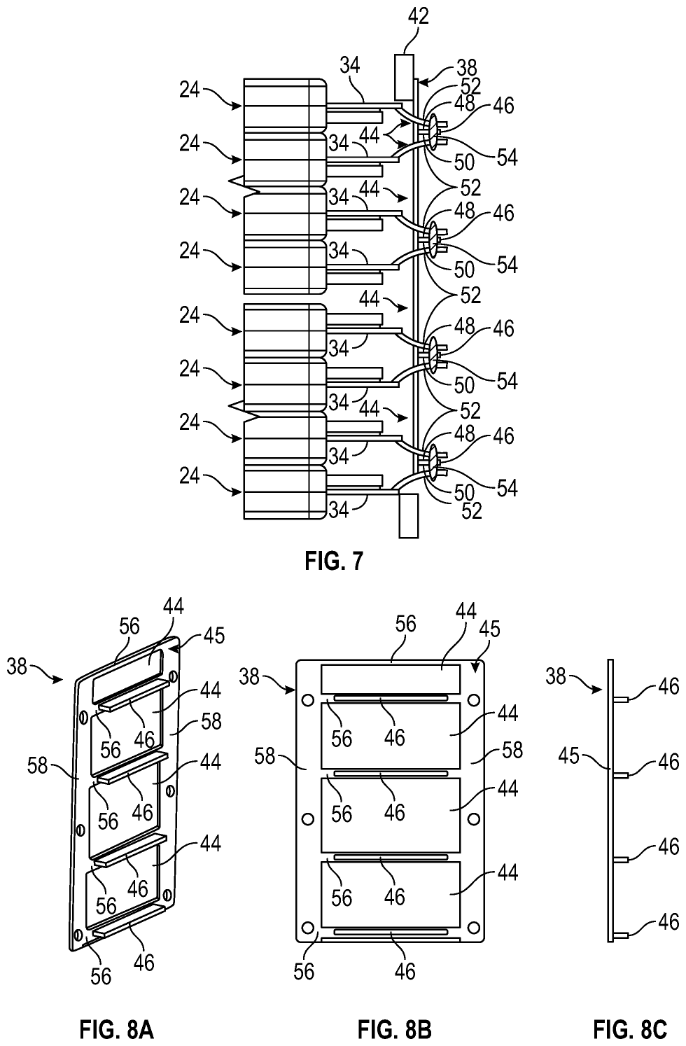

In an embodiment, each end portion 52 of the tab terminals 34 is Z-shaped (see, e.g., FIG. 6). In another embodiment, the end portions 52 are substantially unbent or straight (see, e.g. FIG. 7), although the end portions 52 could include a slight curvature as a result of clamping forces when a clamping device is used as a temporary aid during the joining process, for example.

FIGS. 8A, 8B, and 8C illustrate an exemplary busbar 38 that can be utilized as part of the busbar module 40 described above. In this embodiment, the ribs 46 of the busbar 38 may be configured as T-ribs that extend outwardly from crossbeams 56 of the body 45 of the busbar 38. The crossbeams 56 may connect between outer frame members 58 of the body 45, for example. In an embodiment, the ribs 46 extend at a perpendicular angle relative to the crossbeams 56. However, other configurations are possible within the scope of this disclosure.

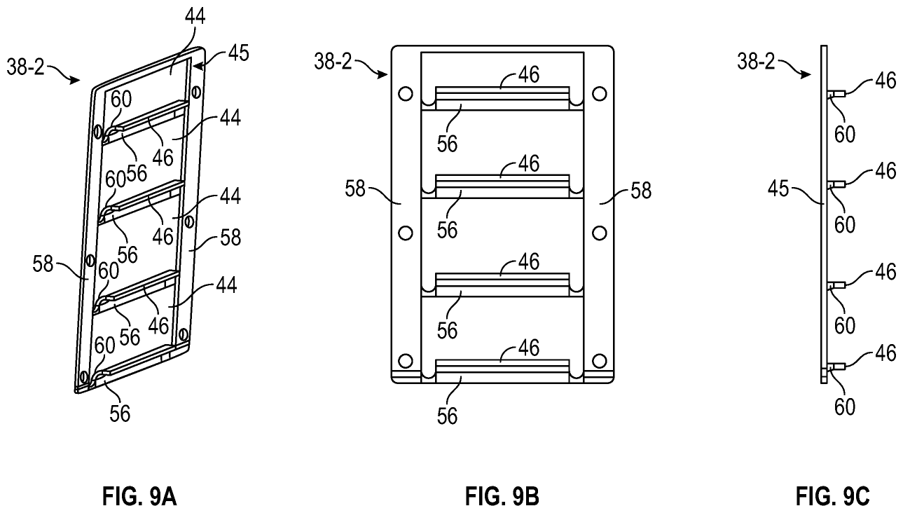

FIGS. 9A, 9B, and 9C illustrate another exemplary busbar 38-2 that can be utilized as part of the busbar module 40 described above. In this embodiment, the ribs 46 of the busbar 38 may be configured as L-bends that are formed by forming a bent portion 60 in the crossbeams 56. The crossbeams 56 may connect between outer frame members 58 of the body 45 of the busbar 38, for example.

The exemplary busbars of this disclosure are designed to conveniently locate and position one or more battery cell tab terminals relative to a rib feature of the busbar. The busbars provide for a more consistent and accurate tab terminal alignment and welding, reduce welding errors, and allow for simple and convenient weld repairs.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

I should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a busbar including a rib;
a first battery cell including a first tab terminal connected to a first side of the rib; and
a second battery cell including a second tab terminal connected to a second side of the rib.

2. The traction battery pack as recited in claim 1, wherein the rib is configured as an L-bend that is established by a bent portion of the busbar.

3. The traction battery pack as recited in claim 2, wherein the bent portion is provided within a crossbeam of the busbar, and further wherein the crossbeam connects between a first frame member and a second frame member of the busbar.

4. The traction battery pack as recited in claim 1, wherein the rib is configured as a T-rib.

5. The traction battery pack as recited in claim 1, wherein the rib extends in a direction away from the first battery cell and the second battery cell.

6. The traction battery pack as recited in claim 1, comprising a weld that secures the first tab terminal to the first side of the rib and secures the second tab terminal to the second side of the rib.

7. The traction battery pack as recited in claim 1, wherein the rib is positioned between a first opening and a second opening formed through the busbar.

8. The traction battery pack as recited in claim 7, wherein a first end portion of the first tab terminal extends through the first opening, and a second end portion of the second tab terminal extends through the second opening.

9. The traction battery pack as recited in claim 8, wherein the first end portion and the second end portion are Z-shaped.

10. The traction battery pack as recited in claim 8, wherein the first end portion and the second end portion are unbent or substantially straight.

11. The traction battery pack as recited in claim 1, wherein the busbar is held within a busbar frame, and further wherein the busbar frame and the busbar establish a bus bar module of the traction battery pack.

12. The traction battery pack as recited in claim 11, wherein the busbar module further includes a second busbar held within the busbar frame.

13. A traction battery pack, comprising:
a busbar including a first opening, a second opening, and a rib between the first opening and the second opening;
a first battery cell including a first housing and a first tab terminal extending from the first housing;
a second battery cell including a second housing and a second tab terminal extending from the second housing,
wherein the first tab terminal extends through the first opening and is connected to a first side of the rib, and the second tab terminal extends through the second opening and is connected to a second side of the rib; and
a weld that secures the first tab terminal, the rib, and the second tab terminal together.

14. The traction battery pack as recited in claim 13, wherein the rib is configured as an L-bend that is established by a bent portion of the busbar.

15. The traction battery pack as recited in claim 13, wherein the rib is configured as a T-rib.

16. The traction battery pack as recited in claim 13, wherein the rib extends in a direction away from the first battery cell and the second battery cell.

17. The traction battery pack as recited in claim 13, wherein a first end portion of the first tab terminal extends through the first opening, and a second end portion of the second tab terminal extends through the second opening.

18. The traction battery pack as recited in claim 17, wherein the first end portion and the second end portion are Z-shaped.

19. The traction battery pack as recited in claim 17, wherein the first end portion and the second end portion are unbent or substantially straight.

20. The traction battery pack as recited in claim 17, wherein the first end portion and the second end portion are positioned on an opposite side of the busbar from the first housing and the second housing.
